(19) United States
(12) Patent Application Publication
(10) Pub. No.: US 2013/0014904 A1
(43) Pub. Date: Jan. 17, 2013

(54) Biaxial Drive Mechanism and Die Bonder

(71) Applicants: Koji HOSAKA, Kumagaya (JP); Shingo Fukasawa, Kumagaya (JP)

(72) Inventors: Koji HOSAKA, Kumagaya (JP); Shingo Fukasawa, Kumagaya (JP)

(73) Assignee: Hitachi High-Tech Instruments Co., Ltd., Kumagaya-shi (JP)

(21) Appl. No.: 13/226,128

(22) Filed: Sep. 6, 2011

(30) Foreign Application Priority Data
Jul. 15, 2011 (JP) 2011-156662

(51) Int. Cl. B29C 65/52; B65G 47/74; B29C 65/48

(52) U.S. Cl. 156/578; 156/538; 414/749.1

(57) ABSTRACT

A biaxial drive mechanism including a Z axis capable of realizing a high speed elevation axis without an increment in torque on a horizontal drive axes and a die bonder using the biaxial drive mechanism is disclosed. The biaxial drive mechanism includes a handling part; a first linear motor having a first movable part that moves up/down the handling part and a first stationary part; a second linear motor having a second movable part and a second stationary part; a connecting part that directly or indirectly connects the first movable part to the second movable part via the first linear guide; a second linear guide that moves the first movable part; and a support body that fixes the first stationary part and the second stationary part with a predetermined length in parallel to each other in the horizontal direction.

### BACKGROUND OF THE INVENTION

The present invention relates to a biaxial drive mechanism including an elevation axis and a die bonder, and more particularly, to a high-speed bonding head as a biaxial drive mechanism including an elevation axis and a high-productivity die bonder.

### DESCRIPTION OF RELATED ART

A die bonder, which is one of semiconductor manufacturing devices, performs bonding of a semiconductor chip (die) to a substrate such as a lead frame. In the die bonder, a bonding head vacuum-sucks a die, then moves upward, then horizontally moves, then moves downward, and bonds the die to the substrate, at a high speed. In such case, a part for up and down movement is an elevation (Z) drive axis.

Recently, there is an increasing need for high-accuracy and high-speed die bonder, and particularly, there is an increasing need for high-speed bonding head as the heart of bonding.

A technique disclosed in Japanese Published Unexamined Patent Application No. 2004-263825 is known as a technique to respond to the above requirement. Generally, when a device operation speed is increased, vibration due to a high-speed moving body is increased, and with this vibration, target accuracy of the device cannot be attained without difficulty. According to Japanese Published Unexamined Patent Application No. 2004-263825, this vibration is reduced with a counter-reaction absorption device, to maintain the accuracy and attain the high operation speed.

### SUMMARY OF THE INVENTION

However, in the servo motor driving using a ball screw as in the case of Japanese Published Unexamined Patent Application No. 2004-263825, high-speed driving is limited. Accordingly, driving with a linear motor appropriate to high speed driving is studied. When a linear motor driving is merely adopted, stator and mover of a Z-axis drive liner motor both apply load on a Y drive axis in a horizontal direction e.g. Y direction to be described later as shown in FIG. 7. When the torque on the Y drive axis is increased, the electric power consumption is increased. When the weight of the stator and mover of a Z-axis drive linear motor is reduced, the torque on the Z axis is reduced and a predetermined high speed cannot be realized.

Accordingly, the present invention has been made in consideration of the above situation, and provides a biaxial drive mechanism including a Z axis which realizes high sped elevation axis without increment in torque on a horizontal drive axis and a die bonder using the biaxial drive mechanism.

To attain the above-described object, the present invention has at least the following features.

According to the present invention, the first feature of the present invention is a biaxial drive mechanism comprising: a handling part; a first linear motor having a first movable part that moves up and down the handling part along a first linear guide and a first stationary part; a second linear motor having a second movable part that moves the handling part in a horizontal direction vertical to a direction of up and down movement and a second stationary part; a connecting part that connects the first movable part via the first linear guide and connects the second movable part directly or indirectly; a second linear guide that moves the first movable part, the second movable part and the connecting part integrally in the horizontal direction; and a support body that fixes the first stationary part and the second stationary part with a predetermined length in parallel to each other in the horizontal direction.

Further, the second feature of the present invention is that the first movable part and the second movable part are provided in parallel or vertical to each other.

Further, the third feature of the present invention is that the second linear guide is provided on the support body provided in a lower part of the second stationary part.

Further, the fourth feature of the present invention is that the second liner guide is provided on the support body in an upper part of the connecting part.

Further, the fifth feature of the present invention is that a plurality of pairs of alternate N pole and S pole electromagnets, provided in the direction of upward/downward movement in the first movable part, are provided in a predetermined region in the horizontal direction.

Further, the sixth feature of the present invention is that a third linear guide is provided between the first stationary part or the second stationary part and the connecting part.

Further, the seventh feature of the present invention is that the handling part in the biaxial drive mechanism in the first to sixth features performs processing on a substrate.

Further, the eighth feature of the present invention is that the handling part is a bonding head that picks up a die from a wafer and bonds the die to the substrate, or a needle that applies a die adhesive to the substrate.

Further, the ninth feature of the present invention is that the predetermined region is a region for pickup and a region for bonding.

Further, the tenth feature of the present invention is that a rotation unit that rotates the handling part about the direction of up and down movement as a rotation axis is provided in the first movable part.

In accordance with the present invention as described above, it is possible to provide a biaxial drive mechanism including a Z axis which realizes high sped elevation axis without increment in torque on a horizontal drive axis and a die bonder using the biaxial drive mechanism.

### BRIEF DESCRIPTION OF THE DRAWINGS

The above and other object, features and advantages of the present invention will become more apparent from the following detailed description when taken in conjunction with the accompanying drawings wherein:

FIG. 1 is a conceptual diagram showing a die bonder according a the first embodiment of the present invention viewed from an upper position;

FIG. 2 is an A-A cross sectional diagram in a position where a bonding head on a ZY drive axes shown in FIG. 1 exists;

FIG. 3 illustrates the ZY drive axes shown in FIG. 2 viewed from an arrow B direction;

FIG. 4 schematically illustrates an example of the basic structure of left and right stationary magnets to move up/down the bonding head in a predetermined position;

FIG. 5 illustrates the basic structure of a ZY drive axes 60B according to a second embodiment of the present invention;

FIG. 6 a illustrates the basic structure of a ZY drive axes 60C according to a third embodiment of the present invention; and

FIG. 7 illustrates a biaxial drive mechanism in which load is applied on a Z axis.

### DETAILED DESCRIPTION OF THE PREFERRED EMBODIMENTS

Hereinbelow, preferred embodiments of the present invention will now be described in accordance with the accompanying drawings.

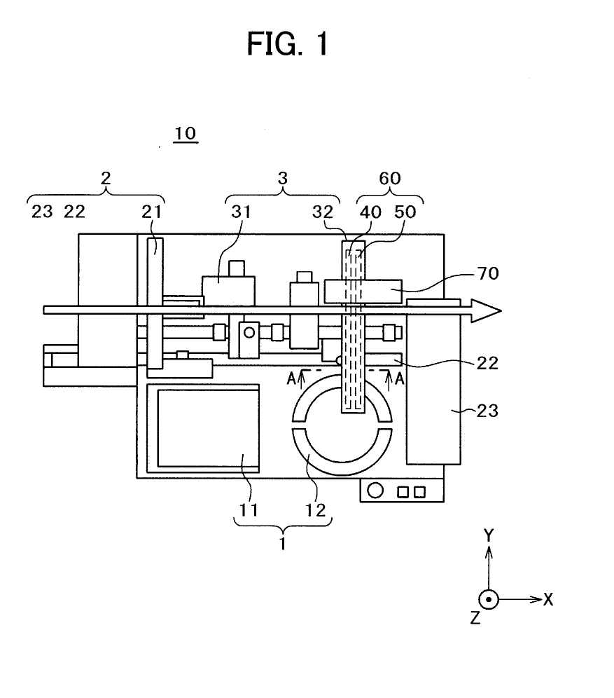

FIG. 1 is a conceptual diagram showing a die bonder 10 according to a first embodiment of the present invention viewed from an upper position. The die bonder 10 briefly has a wafer supply unit 1, a work supply-conveyance unit 2 and a die bonding unit 3.

The wafer supply unit 1 has a wafer cassette lifter 11 and a pickup device 12. The wafer cassette lifter 11, having a wafer cassette (not shown) filled with wafer rings, sequentially supplies the wafer rings to the pickup device 12. The pickup device 12 moves the wafer ring so as to pick up a desired die from the wafer ring.

The work supply-conveyance unit 2 has a stack loader 21, a frame feeder 22 and an unloader 23. The work supply-conveyance unit 2 conveys a work (a substrate such as a lead frame) in an arrow direction. The stack loader 21 supplies a work, to which die is attached, to the frame feeder 22. The frame feeder 22 conveys the work via two processing positions on the frame feeder 22 to the unloader 23. The unloader 23 stores the conveyed work.

The die bonding unit 3 has a preform unit (die paste applicator) 31 and a bonding head unit 32. The preform unit 31 applies a die adhesive to the work conveyed with the frame feeder 22 such as a lead frame with a needle. The bonding head unit 32 picks up the die from the pickup device 12 then moves upward, and moves the die to a bonding point above the frame feeder 22. Then the bonding head 32 moves down the die at the bonding point, and bonds the die to the work on which the die adhesive is applied.

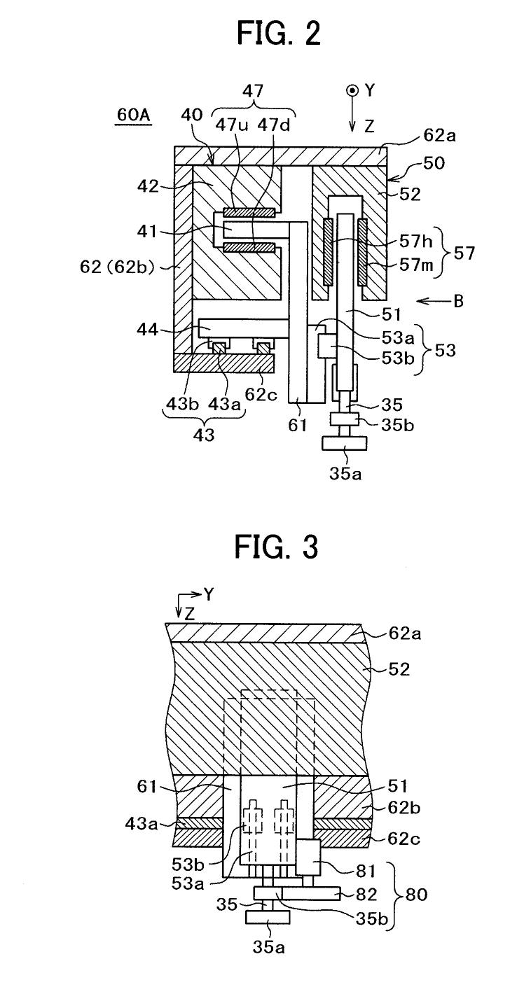

The bonding head unit 32 has a ZY drive axes 60 to elevate the bonding head 35 (see FIG. 2) in a Z (height) direction then move the bonding head 35 in a Y direction, and an X drive axis 70 to move the bonding head 35 in an X direction. The ZY drive axes 60 has a Y drive axis 40 to move the bonding head 35 in the Y direction, i.e., between a pickup position in the wafer ring holder 12 and the bonding point, and a Z drive axis 50 to move the bonding head 35 upward to pick up the die from the wafer or for bonding on the substrate. The X drive axis 70 moves the entire ZY drive axes 60 in the X direction to convey the work. The X drive axis 70 may drive a ball screw with a servo motor or with a liner motor to be described in the structure of the ZY drive axes 60.

Hereinbelow, an embodiment of the ZY drive axes 60 as a feature of the present invention will be described using the drawings.

FIGS. 2 and 3 illustrate a basic structure of a ZY drive axes 60A according to the first embodiment.

FIG. 2 is an A-A cross sectional diagram in a position shown in FIG. 1 in which the bonding head 35 on the ZY drive axes 60 exists. FIG. 3 illustrates the ZY drive axes 60A shown in FIG. 2 viewed from an arrow B direction.

The ZY drive axes 60A according to the first embodiment has the Y drive axis 40, the Z drive axis 50, a connecting part 61 to connect a Y axis movable part 41 of the Y drive axis 40 and a Z axis movable part 51 of the Z drive axis 50, the bonding head 35 as a handling part, a rotation driving unit 80 to rotate the bonding head 35 about the Z axis, and an L-shaped support body 62 to support the entire ZY drive axes 60A. Note that for assistance of understanding of the following explanation, a part fixed to the support body 62 is diagonally hatched, while a part to move integrally with the Y axis movable part 41, the X axis movable part 51 and the connecting part 61 are represented in outline. Further, the support body 62 has an upper support body 62a, a side support body 62b and a lower support body 62c.

The Y drive axis 40 has a C-shaped Y axis stationary part 42 having upper and lower stationary electromagnets 47u and 47d in which a large number of N pole and S pole electromagnets are alternately arrayed in the Y direction (hereinafter, when the electromagnets are generally referred to or any position is not designated, simply denoted by “47”), the Y axis movable part 41, having at least a pair of N pole and S pole electromagnets in the array direction, which is inserted in a C-shaped concave part and moved in the concave part, the connecting part 61 to support the Y axis movable part 41, and a Y axis guide part 44 which is fixed to the connecting part 61, and which has a Y axis linear guide 43 provided between the Y axis guide part and the lower support body 62c. The Y axis stationary part 42 is provided over approximately the whole area of the Y drive axis 40 indicated with a broken line in FIG. 1 such that the Y axis movable part 41 can move in a predetermined range.

Further, the Y axis linear guide 43 has two linear rails 43a extending in the Y direction and a linear slider 43b to move on the linear rails.

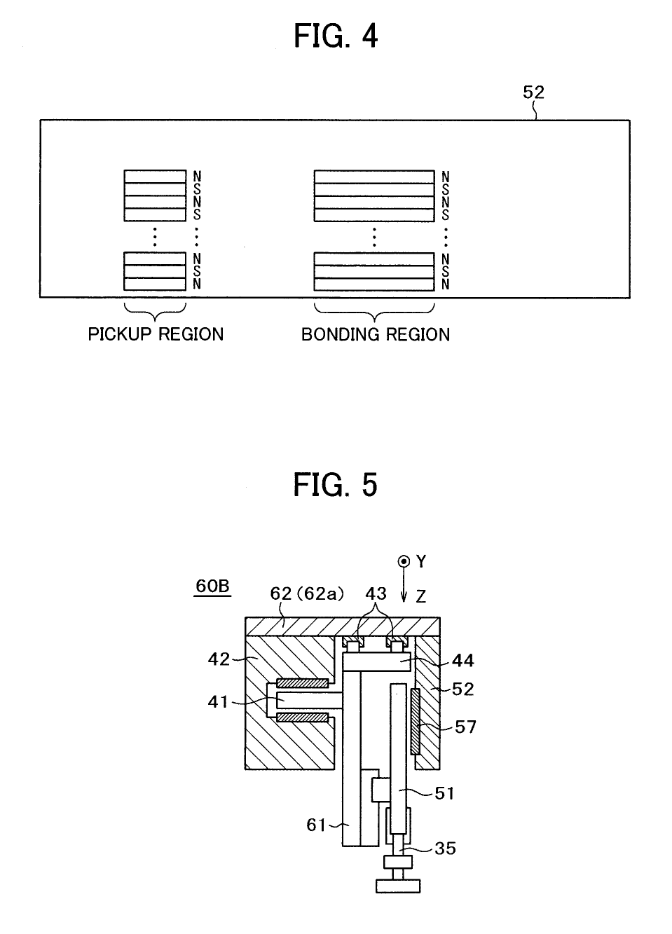

As in the case of the Y drive axis 40, the Z drive axis 50 has a U-shaped Z axis stationary part 52 having right and left stationary electromagnets 57h and 57m in which a large number of N pole and S pole electromagnets are alternately arrayed in the Z direction (see FIG. 4. Hereinafter, when the electromagnets are generally referred to or any position is not designated, simply denoted by “57”), the Z axis movable part 51, having at least a pair of N pole and S pole electromagnets in the array direction of the Z axis stationary part 52 in an upper part, which is inserted in a U-shaped concave part and moved in the concave part, and a Z axis linear guide 53 having a similar structure to that of the Y axis linear guide 43 between the Z axis movable part 51 and the connecting part 61. The Z axis linear guide 53 has two linear rails 53a fixed to the connecting part 61 and expanding in the Z direction and a linear slider 53b which is fixed to the Z axis movable part 51 and which moves on the linear rails.

The Z axis movable part 51 is connected via the connecting part 61 to the Y axis movable part 41. When the Y axis movable part 41 moves in the Y direction, the Z axis movable part 51 also moves in the Y direction. It is necessary to arrange such that the Z axis movable part 51 (bonding head 35) can move upward/downward in a predetermined position in the moving destination.

FIG. 4 schematically illustrates an example of the structure of left and right stationary magnets 57 (57h and 57m) to move up/down the bonding head in a predetermined position. In the present embodiment, spindle N pole and S pole electromagnets are alternately provided at least in a bonding region and a pickup region, in the Y direction. The spindle N pole and S pole electromagnets may be divided into short pieces. It goes without saying that the spindle N pole and S pole electromagnets may be alternately provided in the Y direction over the entire region in the Y direction.

The bonding head 35 is rotatably provided with the rotation driving unit 80 via a gear 35b at the end of the Z axis movable part 51. The bonding head 35 has a collet 35a for die suction at its own end. Further, the rotation driving unit 80 controls the rotational attitude of the bonding head 35 via gears 82 and 35b with a motor 81 fixed to the Z axis movable part 51.

As described above, according to the ZY drive axes 60A according to the present embodiment, the Z axis stationary part 52 is provided approximately over the entire region. In comparison with the structure shown in FIG. 7, as the Z axis stationary part 52 itself as a heavy body does not move, the load with respect to the movement in the Y direction can be greatly reduced. Thus it is possible to realize a high speed elevation axis without increment in torque on the horizontal drive axes.

FIG. 5 illustrates the basic structure of a ZY drive axes 60B according to a second embodiment. In FIG. 5, basically, constituent elements or functions the same as those in the first embodiment have the same reference numerals.

The difference between the ZY drive axes 60B and the ZY drive axes 60A according to the first embodiment is that, first, the Y axis guide 44, to support the Y axis linear guide 43 which enables Y-directional movement of the Y axis movable part 41, moves from the lower support body 62c to the upper support body 62a. Secondly, the Z axis stationary part 52 is not U-shaped but I-shaped, and in place of the stationary magnets 57h and 57m, only one Z axis stationary magnet 57 is used.

The other elements are basically the same as those of the ZY drive axes 60C according to the first embodiment.

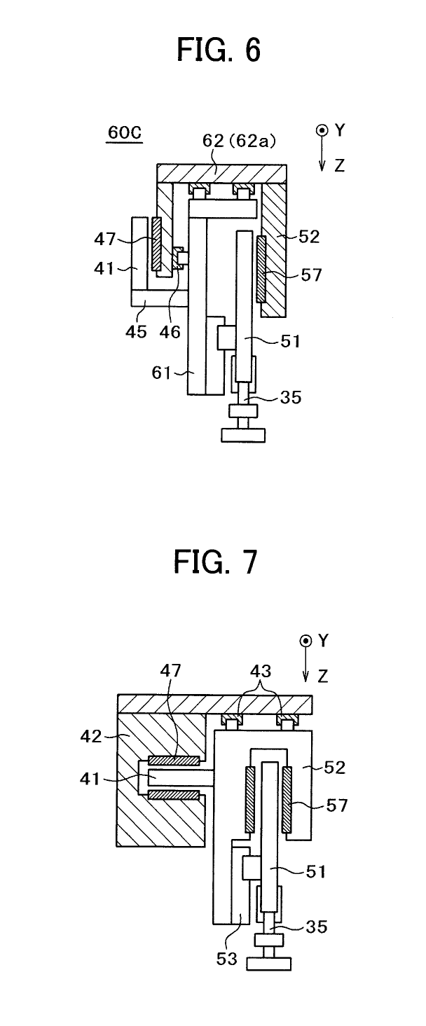

FIG. 6 illustrates the basic structure of a ZY drive axes 60C according to a third embodiment. As in the case of FIG. 5, constituent elements or functions the same as those in the second embodiment have the same reference numbers. The difference between the ZY drive axes 60C and the ZY drive axes 60B according to the second embodiment is that, first, the Y axis stationary part 42 is I-shaped as in the case of the Z axis stationary part 52 according to the second embodiment, and the only one Y axis stationary magnet 47 is used,. Secondly, the Y axis movable-part fixing part 45 for fixing is provided on the Y axis movable part 41 and the connecting part 61. Thirdly, to prevent leftward/rightward swing upon movement in the Y direction, the linear guide 46 is provided between the Y axis stationary part 42 and the connecting part 61.

Note that the linear guide 46 to stabilize such movement may be provided between the Y axis stationary part 42 or the Z axis stationary part 52 and the connecting part 61 in the first and second embodiments.

The other elements are basically the same as those of the ZY drive axes 60B according to the second embodiment. Note that as in the case of the third embodiment, the C-shaped Y drive axis 40 according to the first embodiment may be used.

In the above-described second and third embodiments, as in the case of the first embodiment, in comparison with the structure shown in FIG. 7, as the Z axis stationary part 52 as a heavy body does not move, the load with respect to movement in the Y direction is greatly reduced. Thus it is possible to realize a high-speed elevation axis without increment in torque on a horizontal drive axes.

In the above description, the example of a bonding head is used as a handling part to process something. Basically, the present invention is applicable to a necessary biaxial drive mechanism and a necessary handling part requiring an elevation axis. For example, in a die bonder, the present invention is applicable to a needle to apply a die adhesive to a substrate.

The embodiments of the present invention have been described as above, however, various alternatives, modifications and equivalents can be made by those skilled in the art based on the above description, and it is intended for the subject matter of the invention to include all alternatives, modifications and equivalents within the spirit and scope of the following claims.

What is claimed is:

1. A biaxial drive mechanism comprising:
a handling part;
a first linear motor having a first movable part that moves up and down the handling part along a first linear guide and a first stationary part;
a second linear motor having a second movable part that moves the handling part in a horizontal direction vertical to a direction of up and down movement and a second stationary part;
a connecting part that connects the first movable part via the first linear guide and connects the second movable part directly or indirectly;
a second linear guide that moves the first movable part, the second movable part and the connecting part integrally in the horizontal direction; and
a support body that fixes the first stationary part and the second stationary part with a predetermined length in parallel to each other in the horizontal direction.

2. The biaxial drive mechanism according to claim 1, wherein the first movable part and the second movable part are provided in parallel or vertical to each other.

3. The biaxial drive mechanism according to claim 1, wherein the second linear guide is provided on the support body provided in a lower part of the second stationary part.

4. The biaxial drive mechanism according to claim 1, wherein the second liner guide is provided on the support body in an upper part of the connecting part.

5. The biaxial drive mechanism according to claim 1, wherein a plurality of pairs of alternate N pole and S pole electromagnets, provided in the direction of up and down movement in the first movable part, are provided in a predetermined region in the horizontal direction.

6. The biaxial drive mechanism according to claim 1, wherein a third linear guide is provided between the first stationary part or the second stationary part and the connecting part.

7. A die bonder having the biaxial drive mechanism in claim 1, wherein the handling part performs processing on a substrate.

8. A die bonder having the biaxial drive mechanism in claim 2, wherein the handling part performs processing on a substrate.

9. A die bonder having the biaxial drive mechanism in claim 3, wherein the handling part performs processing on a substrate.

10. A die bonder having the biaxial drive mechanism in claim 4, wherein the handling part performs processing on a substrate.

11. A die bonder having the biaxial drive mechanism in claim 5, wherein the handling part performs processing on a substrate.

12. A die bonder having the biaxial drive mechanism in claim 6, wherein the handling part performs processing on a substrate.

13. The die bonder according to claim 7, wherein the handling part is a bonding head that picks up a die from a wafer and bonds the die to the substrate, or a needle that applies a die adhesive to the substrate.

14. The die bonder according to claim 8, wherein the handling part is a bonding head that picks up a die from a wafer and bonds the die to the substrate, or a needle that applies a die adhesive to the substrate.

15. The die bonder according to claim 9, wherein the handling part is a bonding head that picks up a die from a wafer and bonds the die to the substrate, or a needle that applies a die adhesive to the substrate.

16. The die bonder according to claim 10, wherein the handling part is a bonding head that picks up a die from a wafer and bonds the die to the substrate, or a needle that applies a die adhesive to the substrate.

17. The die bonder according to claim 11, wherein the handling part is a bonding head that picks up a die from a wafer and bonds the die to the substrate, or a needle that applies a die adhesive to the substrate.

18. The die bonder according to claim 12, wherein the handling part is a bonding head that picks up a die from a wafer and bonds the die to the substrate, or a needle that applies a die adhesive to the substrate.

19. A die bonder having the biaxial drive mechanism in claim 5, wherein the handling part is a bonding head that picks up a die from a wafer and bonds the die to the substrate,
and wherein the predetermined region is a region for pickup and a region for bonding.

20. The die bonder according to claim 7, wherein a rotation unit that rotates the handling part about the direction of up and down movement as a rotation axis is provided in the first movable part.
